(19) United States
(12) Patent Application Publication
(10) Pub. No.: US 2003/0146044 A1
(43) Pub. Date: Aug. 7, 2003

(54) Sefety harness with support strap

(76) Inventor: Omar P. Jordan, Twinsburg, OH (US)

Correspondence Address: PEARNE & GORDON LLP, 526 SUPERIOR AVENUE EAST, SUITE 1200, CLEVELAND, OH, 44114-1484, US

(21) Appl. No.: 10/357,015

(22) Filed: Feb. 3, 2003

Related U.S. Application Data
(60) Provisional application No. 60/353,127, filed on Feb. 1, 2002.

(51) Int. Cl. A63B 29/02; E06C 7/18; A47L 3/04; A62B 1/16

(52) U.S. Cl. 182/3

(57) ABSTRACT

A support harness with a support strap for use by a rescue person and/or firefighter, for example. The harness can be used for facilitating escape from upper floors of a building and the rescue of injured people from a building, or to support a person who has lost footing in a rescue or fire-fighting situation. One embodiment of the support harness has an adjustable waist strap with a fastener, a pair of adjustable leg straps, a pair of adjustable rear straps connecting the leg straps to the waist strap, and a support strap connected to the waist strap and the leg straps, with the support strap having a support connector for connecting to a support line.

### CROSS-REFERENCES TO RELATED APPLICATIONS

This application claims the benefit of provisional application serial No. 60/353,127, filed on Feb. 1, 2001, incorporated herein by reference.

This application relates generally to safety harnesses, and more specifically, this application relates to safety harnesses that can be used by firefighters.

### BACKGROUND OF THE INVENTION

Firefighters traditionally wear outer clothing that is known in the art as turnout gear. Turnout gear includes a large coat and pants that have an inner liner and an outer layer. The outer layer or shell is constructed from materials that are resistant to abrasion, flame, heat, and water. The inner liner is releasably secured to the outer layer to permit the liner to the removed for cleaning and repair purposes. The inner liner is preferably constructed from materials which provide a heat and moisture barrier.

Firefighters typically wear turnout gear coat and pants, a helmet, thick gloves, and a large oxygen tank. As can be appreciated, the equipment is heavy and bulky, and there is understandably a great resistance by firefighters to add any further equipment to what is already in use.

Unfortunately for firefighters entering a burning building, especially a high-rise building, the conventional equipment does not include means to facilitate escape from a window or roof of the building. Moreover, for a firefighter who is injured and incapable of escaping from the building, the conventional equipment does not include means to facilitate lifting, lowering, or dragging the injured firefighter from the building.

In the past, an unsatisfactory solution to this problem has been to carry lengths of rope in a coat pocket or a coil of rope over-the-shoulder. However, in a burning building, it takes too long to find the rope, remove it from the pocket, and secure the rope to something/someone to permit escape or rescue. A coil of rope tends to get snagged on things in the building, or is otherwise inconvenient for the firefighter to carry. Therefore, it is common for firefighters to enter tall buildings during a fire with no means of escape.

Accordingly, when a firefighter is trapped several floors above the ground, he must now go to a window and hope that his colleagues can get a ladder up to him before he is injured by the fire. When a firefighter is incapacitated, he must be physically lifted and carried, or dragged by his coat by a rescuer. Due to the failure of conventional equipment to provide means to assist in escape/rescue of firefighters, many firefighters are injured and even killed each year by being unable to escape from upper floors of multi-floor buildings.

Therefore, there exists a need in the art for a means to facilitate escape from upper floors of a building. There also exists a need in the art for a means and method for rescuing incapacitated people from buildings. Additionally, there exists a need in the art for firefighter turnout gear that incorporates such escape and rescue means. Finally, there also exists a need for such capabilities useful in other rescue and/or leisure activities such as mountain climbing and rescue operations, for example.

A number of harnesses have been developed in an attempt to satisfy some of the above determined needs. For example, U.S. Pat. Nos. 6,487,725 & 5,970,517, both incorporated herein by reference, disclose a harness with an integrated support line. However, a general-purpose harness useable with various other support lines would be useful.

Many of the harness units that currently exist have a number of problems and shortcomings that need to be addressed. For example, the connecting ends of current harnesses, when unbuckled, can often lead to the harness device getting separated and spread out, such that it can be difficult for the wearer to easily find the ends to strap the harness together, or the harness can easily get tangled up in firefighting clothing or in the support lines. Further, many currently available harnesses are limited in their ability to be adjusted to closely fit the user, and thus can be uncomfortable when worn, or even maladjusted, preventing their proper functioning. Even further, many existing harnesses often lose their adjustments between being taken off and then put on again, and if not repeatedly re-adjusted when put on, could lead to their failure to function properly in an emergency situation.

In addition, current harnesses can get bunched up when being worn, and don't maintain their position easily. Current harnesses can be difficult to put on and take off, or may not integrate well with the turn-out gear. And if the front strap becomes disconnected, the harness can come apart and fail to support the person, causing injury or even death if the firefighter is not properly supported during an emergency situation. Further, when supporting a person hanging from a height, current harnesses with side connections to support lines often let the user twist around when being supported, perhaps leading to disorientation and possible injury. And those harnesses that utilize leg straps often have the problem that the leg straps get out of position or twisted out of shape when the harness is being handled, because the leg straps are connected to the harness at only one point, making it difficult to put the harness on. Thus, there exists a need in the art to overcome some or all of these problems and shortcomings.

### SUMMARY OF THE INVENTION

Provided is a harness to be worn by a user comprising a waist strap, at least one leg strap connected to the waist strap, and a support strap fixedly connected to the waist strap at two locations, wherein the support strap is adapted for connecting to a safety line.

Also provided is a harness to be worn by a user comprising: a waist strap, at least one leg strap, at least one rear strap connected to both the waist strap and the leg strap, and a support strap connected to one of the waist strap and the leg strap and fixedly connected to the other of the waist strap and the leg strap, wherein the support strap is adapted for connecting to a safety line.

Still further provided is harness to be worn by a user, with the harness comprising a waist strap including: a first waist strap end and a second waist strap end The harness also comprising a first leg strap and a second leg strap for encircling legs of the user, a support strap fixedly connected to one or more of the waist strap, the first leg strap, and the second leg strap, wherein the support strap is adapted for connecting to a safety line.

Even further provided is a harness to be worn by a user with the harness comprising a waist strap including: a first waist strap end, a second waist strap end, and a waist fastener for removably connecting the first waist strap end to the second waist strap end.

The harness further comprising a first leg strap for encircling a first leg of the user; a second leg strap for encircling a second leg of the user; at least one rear strap connected to the waist strap and also connected to at least one of the first leg strap and the second leg strap; and a support strap connected to all of the waist strap, the first leg strap, and the second leg strap, wherein the support strap is adapted for connecting to a safety line.

Also provided is a harness comprising a waist strap including: a first waist strap end; a second waist strap end; and a waist fastener for removably connecting the first waist strap end to the second waist strap end. The harness also comprising a first leg strap; a second leg strap; and a support strap connected to the waist strap at two locations. The support strap including: a first support strap end fixedly connected to the first leg strap; and a second support strap end fixedly connected to the second leg strap. The support strap is further adapted for connecting to a safety line.

And still further provided is a harness comprising: a waist strap; a first rear strap movably connected to the waist strap; a second rear strap movably connected to the waist strap; a first leg strap movably connected to the first rear strap; a second leg strap movably connected to the second rear strap; and a support strap fixedly connected to all of the first leg strap, the second leg strap, and the waist strap.

In addition is provided a harness comprising an adjustable waist strap including: a first waist strap end, a second waist strap end, and a waist fastener for removably connecting the first waist strap end to the second waist strap end.

The harness further comprising an adjustable first rear strap movably connected to the waist strap; an adjustable second rear strap movably connected to the waist strap; an adjustable first leg strap movably connected to the first rear strap; an adjustable second leg strap movably connected to the second rear strap; and a support strap.

The support strap including: a first support strap end fixedly connected to the first leg strap; a second support strap end fixedly connected to the second leg strap; and a support connector for connecting to a safety line, with the support strap fixedly connected to the waist strap near the first waist strap end and also fixedly connected to the waist strap near the second waist strap end.

Additionally provided is a harness comprising: a waist strap including a waist fastener for removably connecting one end of the waist strap to another end of the waist strap; a first leg strap; a second leg strap; a rear strap connected to the waist strap and also connected to at least one of the leg straps; and a support strap.

The support strap includes a first support strap end connected to the first leg strap; a second support strap end connected to the second leg strap; and a support connector at about a midpoint of the support strap.

A part of the support strap is connected to the waist strap at one location, and another part of the support strap is connected to the waist strap at another location.

### BRIEF DESCRIPTION OF THE DRAWINGS

These and further features of the present invention will be apparent with reference to the following description and drawings, wherein:

FIG. 1 is a schematic illustration of the front of the harness in a buckled state, according to the present invention;

FIG. 2 is a schematic illustration of the front of the harness in an unbuckled state, according to the present invention;

FIG. 3 is a schematic illustration of the rear of the harness in a buckled state, according to the present invention; and

FIGS. 4 & 5 are front and back schematic illustrations, respectively, of the harness as it appears worn by a user.

### DETAILED DESCRIPTION OF THE PREFERRED EMBODIMENTS

It should be noted that in the detailed description which follows, identical components have the same reference numeral, regardless of whether they are shown in different embodiments or orientations of the present invention. It should also be noted that, in order to clearly and concisely disclose the present invention, the drawings may not necessarily be to scale and certain features of the invention may be shown in schematic form.

The present invention is directed toward a support harness for facilitating escape from upper floors of a building and rescue of injured people from a building, or to support a person who has lost footing in a rescue or firefighting situation.

The harness comprises an adjustable waist strap having a buckle for removably fastening the ends of the waist strap, a left and right leg strap, also adjustable, a support strap connected to the waist strap at two points near the ends of the waist strap, with the ends of the support strap connected to the left and right leg straps, with the support strap having a support connector for connecting to a support line, with the support connector between the two points at which the support strap connects to the waist strap. The support connector may be movably connected to the support strap, or fixed at about a center position on the support strap. The left leg strap is further movably connected to the waist strap via an adjustable first rear strap, while the right leg strap is further movably connected to the waist strap via an adjustable second rear strap.

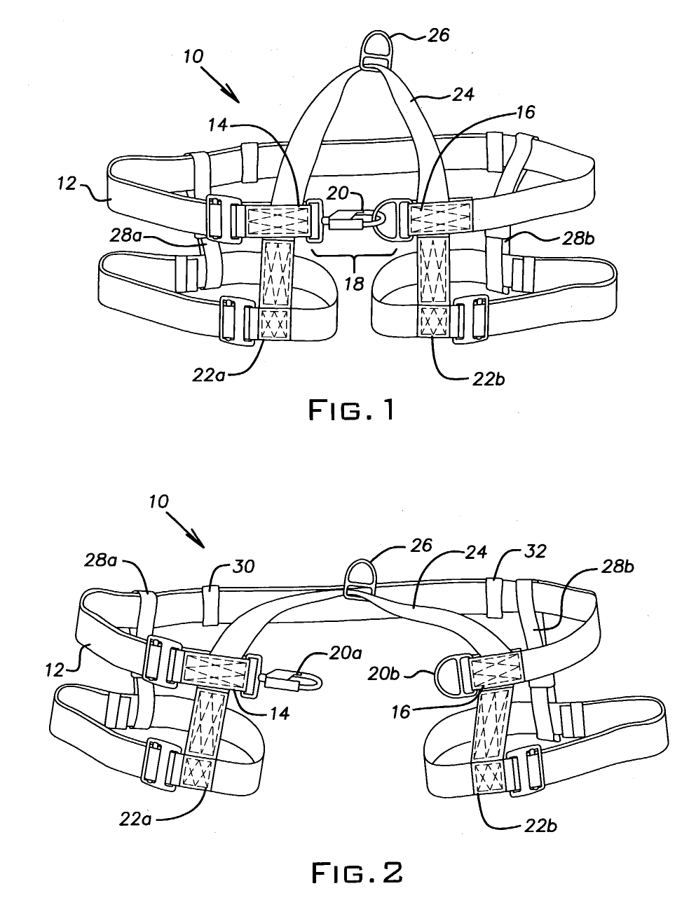

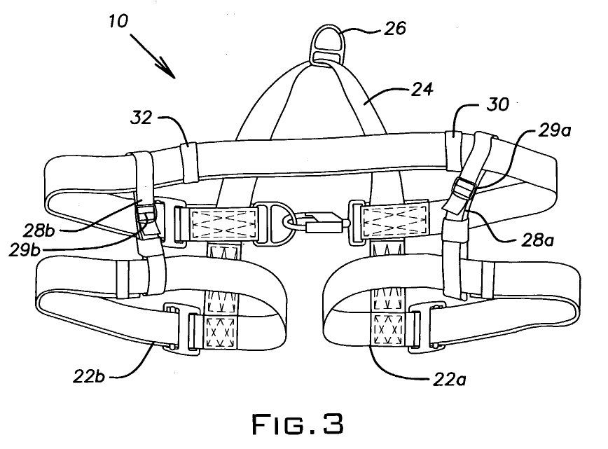

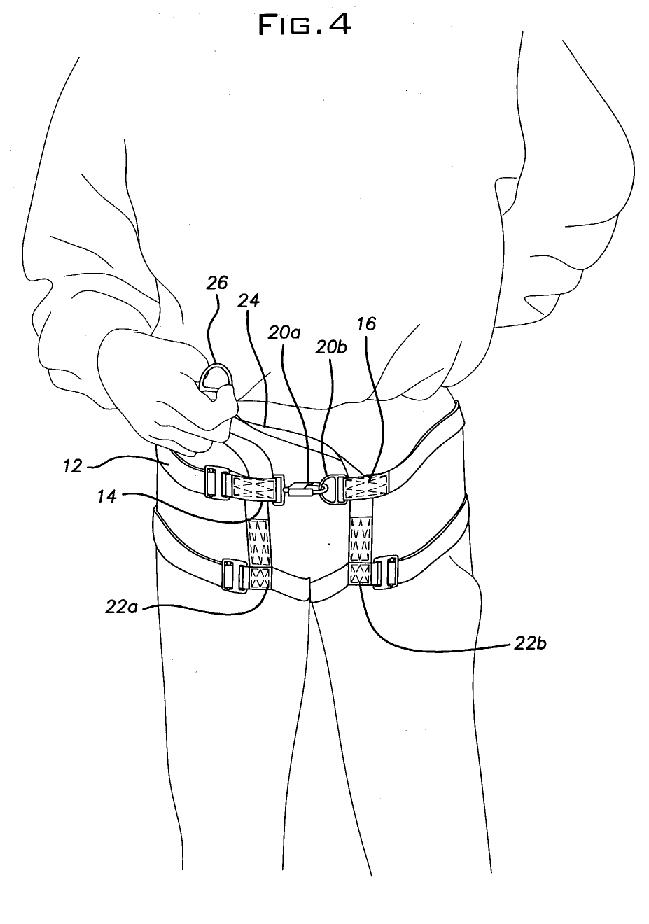

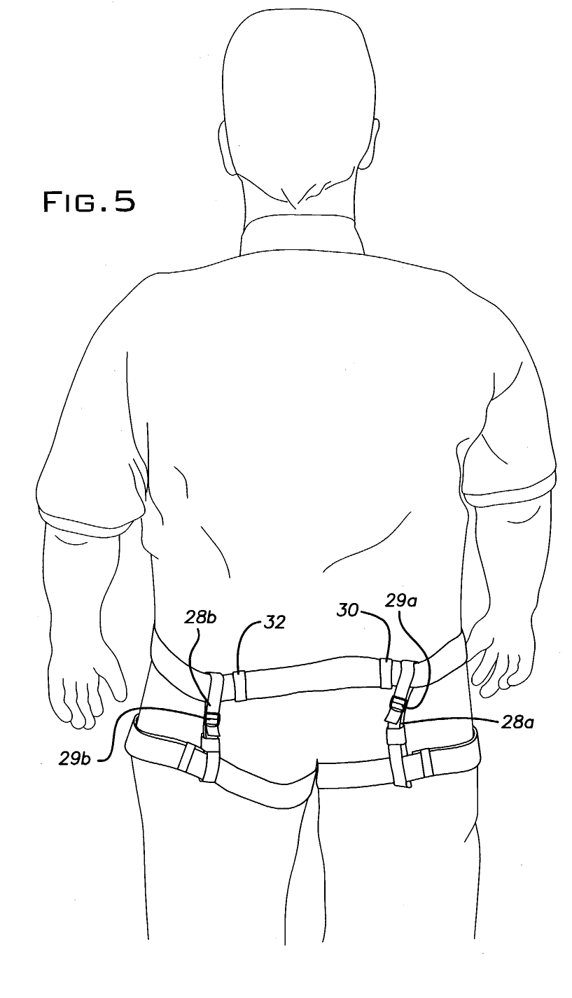

FIG. 1 shows a front view of the harness with support strap 10 [hereinafter “harness 10”] in a buckled state, while FIG. 2 shows the harness in an unbuckled state. FIG. 3 shows the rear of the safety harness 12, with the waist fastener assembly 18 in a fastened state. FIGS. 4 and 5 show the harness as it might be worn by an individual.

The harness as shown in FIG. 1 contains a waist strap 12, with the waist strap having a right end 14 and a left end 16, connected to a waist fastener assembly 18, such as a buckle, for example. The fastener assembly contains, in the embodiment shown, a clip and ring fastener with clip 20a on one end of the waist strap 12 and ring 20b on another end of the waist strap 12. Other fasteners and/or buckles can also be used with the device. The fastener assembly would typically be connected to the ends 14 & 16 of the waist belt in a fixed manner, such as by sewing the fastener assembly portions 20a and 20b into the ends of the waist strap 12. The fastener is fastened together to connect the two ends of the waist strap in a manner shown in FIG. 1, for example, to secure the harness about the waist of the user. The waist strap 12 includes a waist adjusting buckle 23 for adjusting the fit of the waist strap 12 to the waist of the user being fitted with the harness 10.

The harness includes a support strap 24, connected to the waist strap ends 14 and 16. The support strap 24 is a strap, typically made of a similar material as the waist strap, although different materials can be used. An example of support strap 24 is shown in the figures comprised of a single, continuous strap, although alternate structures may be utilized. The support strap 24 connection to the waist strap is typically a fixed connection as shown, for example, such as by sewing a pair of points on the support strap 24 to corresponding points on the waist strap 12, for example, although a moveable connection for one or both points might be acceptable. The ends of the support strap 24 are connected to leg straps, with support strap end 22a shown connected to leg strap 32, and support strap end 22b shown connected to leg strap 34. Again, the connections of the support strap to the leg strap are, for example, typically fixed connections as shown, such as by sewing the straps together, for example, although moveable connections are also possible.

The support strap 24 has support connector 26 for connecting the harness to a support line (support line not shown). The support connector 26 can be movably or fixedly attached to the support strap 24, with a moveable connection shown in the figures as an example. The support strap 24 allows the harness to support the user via the support line even if the fastener assembly 18 is unfastened, either intentionally or by failure of the fastener assembly to hold, or by a failure to properly fasten the fastener assembly 18 when putting the harness 10 on a user. When supporting a user via a support line, even with the fastener assembly unfastened, the support strap 24 with fixed connections to the waist strap would tend to draw the waist strap ends 14 and 16 together, resulting in the harness adequately supporting the user in many cases. The figures show a support connector movably connected to the support strap 24.

Further, the support strap 24 prevents the waist strap ends 14 and 16 from being far separated when the fastener assembly 18 is unfastened, making it easier for the user to put on and take off the harness 10. Still further, the waist adjustment can be maintained when putting the harness on and taking it off, because the support strap 24 allows a loosening of the harness when unfastened without requiring any re-adjustment of the waist strap adjusting buckle 23. This saves time in putting the harness back on. In addition, the fact that support connector 26 on the support strap 24 is can be centered on the harness 12, such that, when a user is hanging from a support line attached to the support connector 26, the user tends to hang in a straight line with less tendency to twist and turn, as apposed to a support line connected to one side or the other of typical safety harnesses.

Right leg strap 32 and left leg strap 34 are adjustable via right leg buckle 36 and left leg buckle 38, respectively. The leg straps 32 and 34 are connected to the support strap 24, as discussed above, and provide additional support when the harness is supporting a user via the support line. Further, the right leg strap 32 is connected to a right rear strap 28a while the left leg strap 34 is connected to a left rear strap 28b. The leg strap connections to the rear strap are typically not fixed, but are moveable connections, for example, using an end of each rear strap looped around the corresponding leg strap and the loop sewed shut. Fixed connections, such as by sewing an end of each rear strap to the corresponding leg strap are also contemplated.

Rear straps 28a and 28b are also connected to the waist strap 12 in a similar manner as the connections to the leg straps, such as by movably connecting using loops of the rear strap ends, or by sewing the rear straps to the waist strap 12. Movable connections on both ends of each rear strap might allow greater flexibility in positioning the straps and in comfort and fit for the user.

Rear straps 28a and 28b help the leg straps 32 and 34 to maintain their position during handling and when putting the harness on the user. In addition, rear straps 28a and 28b help support the rear end of the user when the harness is supporting that user, and the rear straps 28a and 28b provide secondary support for the leg straps 32 and 34. Adjusting buckles 29a and 28b can be included on the rear straps 28a and 28b, respectively, to aid in their adjustment to fit a specific user.

As an additional benefit, one or more of the adjusting buckles can be spring loaded, for example, to prevent slippage during use, and to ease adjustment of the harness. Other means to prevent slippage could also be utilized for the same purposes.

In first use, the harness is put on a user with the user stepping into the waist strap 12 with the right leg going into the right leg strap 32 and the left leg going into the left leg strap 34. The harness is slipped on for the first time with the fastener assembly 18 unfastened, and typically with all adjusting buckles 23, 36, 38,29a and 28b in a loosened position to aid in the process. The support strap 24 goes in the front of the user. Once in place, with the waist strap 12 around the user's waist, the fastener assembly 18 is fastened in front of the user, and the various buckles 23, 36, 38,29a and 29b are tightened to the proper fit. The leg straps 32 and 34 should be positioned such that the support strap 24, between connections 14/16 and 22a/22b, is fully extended. When in use, the support connector 26 is connected to the support line via a suitable fastener (not shown).

The harness can then be removed by disconnecting the support line fastener, and then unfastening the fastener assembly 18. The remaining buckles can typically remain fitted to the user. For subsequent uses, the user repeats the process, but typically will not need to adjust the buckles 23, 36, 38,29a and 29b, except to compensate for harness stretching or changes in the user's body shape or mass, for example, or to be used by a different user. Thus, the harness, once adjusted, typically maintains its adjustment over time, easing its use, and ensuring a proper fit after only a single adjustment, and allowing quicker dressing times. The harness can be used along with firefighting turn-out gear and even integrated therein.

The invention has been described hereinabove using specific examples; however, it will be understood by those skilled in the art that various alternatives may be used and equivalents may be substituted for elements or steps described herein, without deviating from the scope of the invention. Modifications may be necessary to adapt the invention to a particular situation or to particular needs without departing from the scope of the invention. It is intended that the invention not be limited to the particular implementation described herein, but that the claims be given their broadest interpretation to cover all embodiments, literal or equivalent, covered thereby.

What is claimed is:

1. A harness to be worn by a user comprising:
a waist strap;
at least one leg strap connected to said waist strap; and
a support strap fixedly connected to said waist strap at two locations, wherein said support strap is adapted for connecting to a safety line.

2. The harness of claim 1, wherein said support strap is also fixedly connected to said at least one leg strap.

3. The harness of claim 1, wherein said at least one leg strap is adjustable in length.

4. The harness of claim 1, said waist strap including a first end and a second end, wherein said support strap restrains said first end from being removed a full distance from said second end.

5. The harness of claim 4, wherein said support strap is continuous.

6. The harness of claim 1, wherein said support strap is continuous.

7. The harness of claim 6, wherein said support strap forms a loop.

8. The harness of claim 1, further comprising at least one rear strap connected to both said waist strap and said at least one leg strap.

9. The harness of claim 8, wherein said at least one rear strap is movably connected to one or both of said waist strap and said at least one leg strap.

10. The harness of claim 1, further comprising:
another leg strap connected to said waist strap;
a first rear strap connected to said at least one leg strap and said waist strap; and
a second rear strap connected to said another leg strap and said waist strap.

11. A harness to be worn by a user comprising:
a waist strap;
at least one leg strap;
at least one rear strap connected to both said waist strap and said at least one leg strap; and
a support strap connected to one of said waist strap and said at least one leg strap and fixedly connected to the other of said waist strap and said at least one leg strap, wherein said support strap is adapted for connecting to a safety line.

12. The harness of claim 11, wherein said at least one rear strap is movably connected to one or both of said waist strap and said at least one leg strap.

13. The harness of claim 11, wherein said support strap is connected to said waist strap at two locations.

14. The harness of claim 11, wherein said support strap is fixedly connected to both said waist strap and said at least one leg strap.

15. The harness of claim 11, wherein said at least one leg strap has an adjustable length.

16. The harness of claim 11, wherein said waist strap is continuous.

17. A harness to be worn by a user, said harness comprising:
a waist strap including:
a first waist strap end; and
a second waist strap end;
a first leg strap for encircling a first leg of the user;
a second leg strap for encircling a second leg of the user; and
a support strap fixedly connected to one or more of said waist strap, said first leg strap, and said second leg strap, wherein said support strap is adapted for connecting to a safety line.

18. The harness of claim 17, wherein said first and said second leg straps each have an adjustable length.

19. The harness of claim 17, further comprising:
a first rear strap connected to both said waist strap and said first leg strap; and
a second rear strap connected to both said waist strap and said second leg strap.

20. The harness of claim 17, further comprising:
a first rear strap movably connected to both said waist strap and said first leg strap; and
a second rear strap movably connected to both said waist strap and said second leg strap.

21. The harness of claim 17, wherein said support strap is fixedly connected to said waist strap at two locations, and further wherein said support strap is fixedly connected to both said first leg strap and said second leg strap.

22. The harness of claim 17, wherein said support strap is continuous.

23. A harness to be worn by a user, said harness comprising:
a waist strap including:
a first waist strap end;
a second waist strap end; and
a waist fastener for removably connecting said first waist strap end to said second waist strap end;
a first leg strap for encircling a first leg of the user;
a second leg strap for encircling a second leg of the user;
at least one rear strap connected to said waist strap and also connected to at least one of said first leg strap and said second leg strap; and
a support strap connected to all of said waist strap, said first leg strap, and said second leg strap, wherein said support strap is adapted for connecting to a safety line.

24. The harness of claim 23, wherein said support strap is connected to said waist strap at two locations, and further wherein said support strap is fixedly connected to both said first leg strap and said second leg strap.

25. The harness of claim 23 further comprising another rear strap connected to said second leg strap, wherein said at least one rear strap is connected to said first leg strap, and further wherein said rear straps are each connected to said waist strap at different locations.

26. The harness of claim 23, wherein said support strap is continuous.

27. A harness comprising:
a waist strap including:
a first waist strap end;
a second waist strap end; and
a waist fastener for removably connecting said first waist strap end to said second waist strap end;
a first leg strap;
a second leg strap; and
a support strap connected to said waist strap at two locations, said support strap including:
a first support strap end fixedly connected to said first leg strap; and
a second support strap end fixedly connected to said second leg strap,
wherein said support strap is adapted for connecting to a safety line.

28. The harness of claim 27, wherein said support connector is movably connected to said support strap.

29. The harness of claim 27, wherein said support connector is fixedly connected to said support strap at about a center position on said support strap.

30. The harness of claim 27, wherein said support strap is continuous.

31. A harness comprising:
a waist strap:
a first rear strap movably connected to said waist strap;
a second rear strap movably connected to said waist strap;
a first leg strap movably connected to said first rear strap;
a second leg strap movably connected to said second rear strap; and
a support strap fixedly connected to all of said first leg strap, said second leg strap, and said waist strap.

32. The harness of claim 31, wherein said support strap is continuous.

33. The harness of claim 31, wherein said support strap is fixedly connected to said waist strap at two or more locations.

34. A harness comprising:
an adjustable waist strap including:
a first waist strap end;
a second waist strap end; and
a waist fastener for removably connecting said first waist strap end to said second waist strap end;
an adjustable first rear strap movably connected to said waist strap;
an adjustable second rear strap movably connected to said waist strap;
an adjustable first leg strap movably connected to said first rear strap;
an adjustable second leg strap movably connected to said second rear strap; and
a support strap including:
a first support strap end fixedly connected to said first leg strap;
a second support strap end fixedly connected to said second leg strap; and
a support connector for connecting to a safety line,
wherein said support strap is fixedly connected to said waist strap near said first waist strap end and also fixedly connected to said waist strap near said second waist strap end.

35. The harness of claim 34, wherein said support strap is continuous.

36. A harness comprising:
a waist strap including a waist fastener for removably connecting one end of said waist strap to another end of said waist strap;
a first leg strap;
a second leg strap;
a rear strap connected to said waist strap and also connected to at least one of said leg straps; and
a support strap including:
a first support strap end connected to said first leg strap;
a second support strap end connected to said second leg strap; and
a support connector at about a midpoint of said support strap,
wherein a part of said support strap is connected to said waist strap at one location, and wherein another part of said support strap is connected to said waist strap at another location.

37. The harness of claim 36, wherein said support strap is continuous.

38. The harness of claim 36, wherein said support strap forms a loop.
